(19) United States
(12) Patent Application Publication
(10) Pub. No.: US 2025/0286092 A1
(43) Pub. Date: Sep. 11, 2025

(54) FUEL CELL VEHICLE AND A METHOD OF CONTROLLING TEMPERATURE THEREOF

(71) Applicants: HYUNDAI MOTOR COMPANY, Seoul (KR); KIA CORPORATION, Seoul (KR)

(72) Inventor: Hyun Ho Kim, Hwaseong-si (KR)

(73) Assignees: HYUNDAI MOTOR COMPANY, Seoul (KR); KIA CORPORATION, Seoul (KR)

(21) Appl. No.: 18/967,260

(22) Filed: Dec. 3, 2024

(30) Foreign Application Priority Data
Mar. 11, 2024 (KR) 10-2024-0033919

(51) Int. Cl. H01M 8/04701; B60L 58/33; H01M 8/04007

(52) U.S. Cl. CPC H01M 8/04701; B60L 58/33; H01M 8/04059; H01M 8/04731; H01M 2250/20

(57) ABSTRACT

Disclosed are a fuel cell vehicle and a method of controlling the temperature thereof. The fuel cell vehicle includes a first cooling unit configured to cool a first device, a second cooling unit configured to cool a second device, and a temperature regulator configured to lower the temperature of one of the first and second cooling units and to increase the temperature of the other of the first and second cooling units. The first device and the second device have different degrees of heat generation.

### CROSS-REFERENCE TO RELATED APPLICATION

This application claims the benefit of and priority to Korean Patent Application No. 10-2024-0033919, filed on Mar. 11, 2024, the entire contents of which are incorporated herein by reference.

### BACKGROUND

### Field

The present disclosure relates to a fuel cell vehicle and a method of controlling the temperature thereof.

### Related Art

In order to respond to climate change, development of eco-friendly vehicles capable of reducing carbon emissions is being actively carried out around the world. In the case of large trucks, diesel engines are mainly mounted therein in order to provide a long driving range and to produce high output. Diesel engines generate exhaust gases, such as NOx, Pm, and carbon dioxide, during a fuel combustion process, thus accelerating global warming. In order to reduce carbon emissions caused by the driving characteristics of trucks, research on eco-friendly vehicles using hydrogen is being actively conducted around the world.

A fuel cell electric vehicle (FCEV) (hereinafter referred to as a “fuel cell vehicle”) is a vehicle that is driven using electrical energy created through a chemical reaction between hydrogen and oxygen. Such a fuel cell vehicle has advantages in that there are no carbon emissions and it is easy to store and transport fuel. In addition, because a hydrogen charging time is relatively short and the driving range is relatively long, the fuel cell vehicle is more suitable for large trucks than other types of eco-friendly vehicles. In spite of the aforementioned advantages, the fuel cell vehicle has problems to be solved.

While an internal combustion engine needs to be managed to maintain its temperature within a range of 110° C. to 120° C., a fuel cell needs to be managed to keep its temperature within a range of 70° C. to 80° C. Because a difference between the management temperature of a fuel cell and the outside air temperature of a vehicle is relatively small compared to an internal combustion engine, if the same cooling module as that of the internal combustion engine is applied to the fuel cell, cooling performance thereof may be reduced. Further, because the fuel cell has no exhaust system unlike the internal combustion engine, 50% of input energy is transferred as cooling heat, and thus cooling requirements inevitably increase. Thus, in the case of a fuel cell vehicle using a fuel cell, the size and number of cooling modules for cooling a cell stack of the fuel cell increase.

In addition, due to electrification of a fuel cell vehicle, it is necessary to cool not only a fuel cell but also other parts, such as a motor, a power electronic (PE) module, an automatic transmission (ATM), and a high-voltage battery. Numerically, while the number of parts to be cooled in an internal combustion engine vehicle is four to six, the number of parts to be cooled in a fuel cell vehicle is twenty to thirty, which is about five times that in the internal combustion engine vehicle. However, because the size of a fuel cell vehicle is restricted, it is difficult to infinitely increase the size or number of cooling modules in order to cool a relatively large number of parts of the fuel cell vehicle. Further, considering the size of a passenger compartment, the size of a cargo carrying space, and a payload, the size of a space occupied by a cooling system in a fuel cell vehicle is about three to four times that in an internal combustion engine vehicle equipped with, for example, a diesel engine. Therefore, research with the goal of maximizing cooling performance within a limited space is underway.

### SUMMARY

Embodiments of the present disclosure are directed to a fuel cell vehicle and a method of controlling the temperature thereof that substantially obviate one or more problems due to limitations and disadvantages of the related art.

The present disclosure provides a fuel cell vehicle having excellent cooling performance and a method of controlling the temperature thereof.

The objects to be accomplished by the embodiments are not limited to the above-mentioned objects, and other objects not mentioned herein should be clearly understood by those having ordinary skill in the art from the following description.

Additional advantages, objects, and features of the disclosure will be set forth in part in the description which follows and in part should become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

In an embodiment of the present disclosure, a fuel cell vehicle may include: a first cooling unit configured to cool a first device, a second cooling unit configured to cool a second device, and a temperature regulator configured to lower the temperature of one of the first and second cooling units and to increase the temperature of the other of the first and second cooling units. In particular, the first device and the second device may have different degrees of heat generation.

In an embodiment, the first device may include a fuel cell or a power electronic part, and the second device may include an automatic transmission related to auxiliary braking.

In an embodiment, the first cooling unit may include a first radiator configured to cool a first coolant having cooled the first device, and the second cooling unit may include a second radiator configured to cool a second coolant having cooled the second device.

In an embodiment, the temperature regulator may include a first condenser/evaporator configured to absorb heat from air to be supplied to the first radiator or emit heat to the air, a second condenser/evaporator configured to absorb heat from air to be supplied to the second radiator or to emit heat to the air, a compressor disposed between the first condenser/evaporator and the second condenser/evaporator, at least one expansion valve disposed between the first condenser/evaporator and the second condenser/evaporator, and a plurality of 3-way valves disposed at at least one of an inlet or an outlet of each of the first condenser/evaporator and the second condenser/evaporator, at least one of an inlet or an outlet of the compressor, and at least one of an inlet or an outlet of the at least one expansion valve.

In an embodiment, the fuel cell vehicle may further include a controller configured to generate control signals for control of passages of the plurality of 3-way valves to allow one of the first condenser/evaporator and the second condenser/evaporator to operate as a condenser and the other of the first condenser/evaporator and the second condenser/evaporator to operate as an evaporator.

In an embodiment, the controller may generate the control signals in response to at least one of the outside air temperature, the temperature of the first coolant having cooled the first device, or the temperature of the second coolant having cooled the second device.

In an embodiment, the at least one expansion valve may include a first expansion valve disposed between the inlet of the first condenser/evaporator and the outlet of the second condenser/evaporator and a second expansion valve disposed between the outlet of the first condenser/evaporator and the inlet of the second condenser/evaporator. The plurality of 3-way valves may include a 1-1^{st} 3-way valve connected to an outlet of the first expansion valve, the compressor, and the inlet of the first condenser/evaporator, a 1-2^{nd} 3-way valve connected to an outlet of the second expansion valve, the compressor, the 1-1^{st} 3-way valve, and the inlet of the second condenser/evaporator, a 1-3^{rd} 3-way valve connected to an inlet of the second expansion valve, the compressor, and the outlet of the first condenser/evaporator, and a 1-4^{th} 3-way valve connected to an inlet of the first expansion valve, the compressor, and the outlet of the second condenser/evaporator.

In an embodiment, the control signals may include 1-1^{st} to 1-4^{th} control signals for respective control of the 1-1^{st} to 1-4^{th} 3-way valves. When the 1-1^{st} to 1-4^{th} control signals are at a first level, the 1-1^{st} 3-way valve may connect the outlet of the first expansion valve to the inlet of the first condenser/evaporator in response to the first-level 1-1^{st} control signal, the 1-2^{nd} 3-way valve may connect the compressor to the inlet of the second condenser/evaporator in response to the first-level 1-2^{nd} control signal, the 1-3^{rd} 3-way valve may connect the compressor to the outlet of the first condenser/evaporator in response to the first-level 1-3^{rd} control signal, and the 1-4^{th} 3-way valve may connect the inlet of the first expansion valve to the outlet of the second condenser/evaporator in response to the first-level 1-4^{th} control signal.

In an embodiment, when the 1-1^{st} to 1-4^{th} control signals are at a second level, the 1-1^{st} 3-way valve may connect the compressor to the inlet of the first condenser/evaporator in response to the second-level 1-1^{st} control signal, the 1-2^{nd} 3-way valve may connect the outlet of the second expansion valve to the inlet of the second condenser/evaporator in response to the second-level 1-2^{nd} control signal, the 1-3^{rd} 3-way valve may connect the inlet of the second expansion valve to the outlet of the first condenser/evaporator in response to the second-level 1-3^{rd} control signal, and the 1-4^{th} 3-way valve may connect the compressor to the outlet of the second condenser/evaporator in response to the second-level 1-4^{th} control signal.

In an embodiment, the at least one expansion valve may include a third expansion valve, and the plurality of 3-way valves may include a 2-1^{st} 3-way valve connected to the outlet of the first condenser/evaporator, a 2-2^{nd} 3-way valve connected to the compressor and the 2-1^{st} 3-way valve, a 2-3^{rd} 3-way valve connected to the outlet of the second condenser/evaporator and the 2-2^{nd} 3-way valve, a 2-4^{th} 3-way valve connected to an inlet of the third expansion valve, the 2-3^{rd} 3-way valve, and the 2-1^{st} 3-way valve, a 2-5^{th} 3-way valve connected to an outlet of the third expansion valve, a 2-6^{th} 3-way valve connected to the 2-5^{th} 3-way valve and the inlet of the first condenser/evaporator, a 2-7^{th} 3-way valve connected to the compressor and the 2-6^{th} 3-way valve, and a 2-8th 3-way valve connected to the inlet of the second condenser/evaporator, the 2-7^{th} 3-way valve, and the 2-5^{th} 3-way valve.

In an embodiment, the control signals may include 2-1^{st} to 2-8^{th} control signals for respective control of the 2-1^{st} to 2-8th 3-way valves. When the 2-1^{st} to 2-8^{th} control signals are at a first level, the 2-1^{st} 3-way valve may connect the 2-2^{nd} 3-way valve to the outlet of the first condenser/evaporator in response to the first-level 2-1^{st} control signal, the 2-2^{nd} 3-way valve may connect the 2-1^{st} 3-way valve to the compressor in response to the first-level 2-2^{nd} control signal, the 2-3^{rd} 3-way valve may connect the 2-4^{th} 3-way valve to the outlet of the second condenser/evaporator in response to the first-level 2-3^{rd} control signal, the 2-4^{th} 3-way valve may connect the 2-3^{rd} 3-way valve to the inlet of the third expansion valve in response to the first-level 2-4^{th} control signal, the 2-5^{th} 3-way valve may connect the outlet of the third expansion valve to the 2-6^{th} 3-way valve in response to the first-level 2-5^{th} control signal, the 2-6^{th} 3-way valve may connect the 2-5^{th} 3-way valve to the inlet of the first condenser/evaporator in response to the first-level 2-6^{th} control signal, the 2-7^{th} 3-way valve may connect the 2-8^{th} 3-way valve to the compressor in response to the first-level 2-7^{th} control signal, and the 2-8^{th} 3-way valve may connect the 2-7^{th} 3-way valve to the inlet of the second condenser/evaporator in response to the first-level 2-8^{th} control signal.

In an embodiment, when the 2-1^{st} to 2-8^{th} control signals are at a second level, the 2-1^{st} 3-way valve may connect the 2-4th 3-way valve to the outlet of the first condenser/evaporator in response to the second-level 2-1^{st} control signal, the 2-2^{nd} 3-way valve may connect the 2-3^{rd} 3-way valve to the compressor in response to the second-level 2-2^{nd} control signal, the 2-3^{rd} 3-way valve may connect the 2-2^{nd} 3-way valve to the outlet of the second condenser/evaporator in response to the second-level 2-3^{rd} control signal, the 2-4^{th} 3-way valve may connect the 2-1^{st} 3-way valve to an inlet of the third expansion valve in response to the second-level 2-4^{th} control signal, the 2-5^{th} 3-way valve may connect an outlet of the third expansion valve to the 2-8^{th} 3-way valve in response to the second-level 2-5^{th} control signal, the 2-6^{th} 3-way valve may connect the 2-7^{th} 3-way valve to the inlet of the first condenser/evaporator in response to the second-level 2-6^{th} control signal, the 2-7^{th} 3-way valve may connect the 2-6^{th} 3-way valve to the compressor in response to the second-level 2-7^{th} control signal, and the 2-8^{th} 3-way valve may connect the 2-5^{th} 3-way valve to the inlet of the second condenser/evaporator in response to the second-level 2-8^{th} control signal.

According to another embodiment, a method of controlling the temperature of the fuel cell vehicle may include determining whether the outside air temperature is higher than a first predetermined temperature, when the outside air temperature is higher than the first predetermined temperature, determining whether the temperature of the first coolant is higher or lower than a second predetermined temperature and whether the temperature of the second coolant is higher or lower than a third predetermined temperature, when the temperature of the first coolant is higher than the second predetermined temperature and when the temperature of the second coolant is lower than the third predetermined temperature, generating the control signals to have the first level, and when the temperature of the first coolant is lower than the third predetermined temperature and when the temperature of the second coolant is higher than the second predetermined temperature, generating the control signals to have the second level.

Another embodiment of the present disclosure provides a method of controlling a temperature of a fuel cell vehicle including a first cooling unit, a second cooling unit and a temperature regulator to control a temperature of the first and second cooling units, where the first cooling unit includes a first radiator configured to cool a first coolant having cooled a first device, and the second cooling unit includes a second radiator configured to cool a second coolant having cooled a second device. The method includes: determining whether an outside air temperature is higher than a first predetermined temperature; when the outside air temperature is higher than the first predetermined temperature, determining whether a temperature of the first coolant is higher or lower than a second predetermined temperature and whether a temperature of the second coolant is higher or lower than a third predetermined temperature, wherein the first device and the second device have different degrees of heat generation; when the temperature of the first coolant is higher than the second predetermined temperature and when the temperature of the second coolant is lower than the third predetermined temperature, generating, by a controller, a first control signal to have a first level; and when the temperature of the first coolant is lower than the third predetermined temperature and when the temperature of the second coolant is higher than the second predetermined temperature, generating, by the controller, control signal to have a second level. In particular, upon receiving the first and second controls, passages of a plurality of 3-way valves are controlled to allow one of a first condenser/evaporator and a second condenser/evaporator to operate as a condenser and a remaining one of the first condenser/evaporator and the second condenser/evaporator to operate as an evaporator.

According to still another embodiment, a method of controlling the temperature of a fuel cell vehicle including first and second cooling units, respectively including first and second devices having different degrees of heat generation, and a temperature regulator configured to lower the temperature of one of the first and second cooling units and to increase the temperature of the other of the first and second cooling units may include checking whether the outside air temperature is higher than a first predetermined temperature, when the outside air temperature is higher than the first predetermined temperature, when the temperature of first coolant having cooled the first device is higher than a second predetermined temperature, and when the temperature of second coolant having cooled the second device is lower than a third predetermined temperature, assisting in cooling of the first cooling unit through the temperature regulator, and when the outside air temperature is higher than the first predetermined temperature, when the temperature of the first coolant is lower than the third predetermined temperature, and when the temperature of the second coolant is higher than the second predetermined temperature, assisting in cooling of the second cooling unit through the temperature regulator.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram of a fuel cell vehicle according to an embodiment;

FIG. 2 is a block diagram embodiment of a first cooling unit shown in FIG. 1;

FIG. 3 is a block diagram of an embodiment of a second cooling unit shown in FIG. 1;

FIG. 4 is a block diagram of an embodiment of a temperature regulator shown in FIG. 1;

FIG. 5A is a block diagram for explaining a first operation example of the temperature regulator shown in FIG. 4;

FIG. 5B is a block diagram for explaining a second operation example of the temperature regulator shown in FIG. 4;

FIG. 6 is a block diagram of another embodiment of a temperature regulator shown in FIG. 1;

FIG. 7A is a block diagram for explaining a third operation example of the temperature regulator shown in FIG. 6;

FIG. 7B is a block diagram for explaining a fourth operation example of the temperature regulator shown in FIG. 6;

FIG. 8 is a flowchart for explaining a method of controlling the temperature of the fuel cell vehicle according to an embodiment; and

FIGS. 9A and 9B are block diagrams of the fuel cell vehicle according to an embodiment.

### DETAILED DESCRIPTION OF THE PRESENT DISCLOSURE

The present disclosure is described more fully hereinafter with reference to the accompanying drawings, in which various embodiments are shown. The described embodiments, however, may be embodied in many different forms, and should not be construed as being limited to the embodiments set forth herein. Rather, these embodiments are provided so that this disclosure will be more thorough and complete, and more fully conveys the scope of the disclosure to those having ordinary skill in the art.

It should be understood that when an element is referred to as being “on” or “under” another element, it may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

When a component, device, element, or the like of the present disclosure is described as having a purpose or performing an operation, function, or the like, the component, device, or element should be considered herein as being “configured to” meet that purpose or to perform that operation or function.

Hereinafter, a fuel cell vehicle 100 according to an embodiment described with reference to the accompanying drawings.

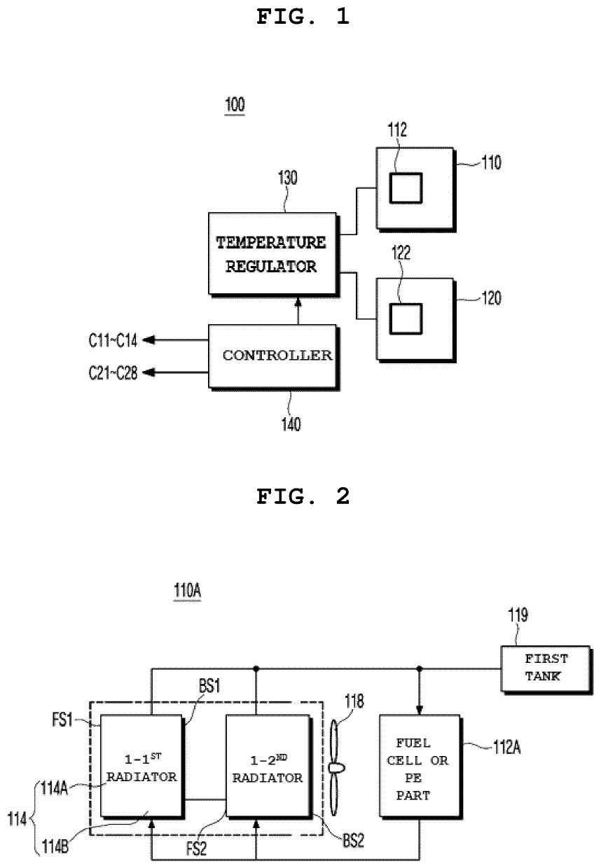

FIG. 1 is a block diagram of a fuel cell vehicle 100 according to an embodiment.

The fuel cell vehicle 100 shown in FIG. 1 includes first and second cooling units 110 and 120, a temperature regulator 130, and a controller 140.

The first cooling unit 110 includes a first device 112 and cools the first device 112, and the second cooling unit 120 includes a second device 122 and cools the second device 122.

The first device 112 may include a fuel cell or a power electronic (PE) part, and the second device 122 may include an automatic transmission (ATM) related to auxiliary braking.

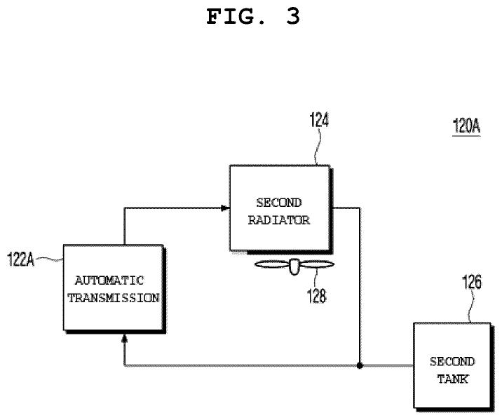

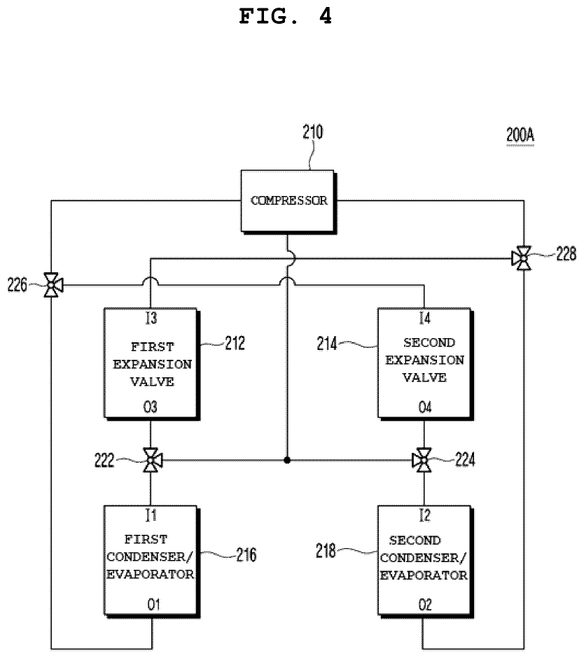

FIG. 2 is a block diagram of an embodiment 110A of the first cooling unit 110 shown in FIG. 1, and FIG. 3 is a block diagram of an embodiment 120A of the second cooling unit 120 shown in FIG. 1.

The first cooling unit 110A shown in FIG. 2 may include a fuel cell or a PE part 112A, a first radiator 114 (a 1-1^{st} radiator 114A and a 1-2^{nd} radiator 114B), a cooling fan (hereinafter referred to as a “fan”) 118, and a first tank 119.

The fuel cell 112A may be, for example, a polymer electrolyte membrane fuel cell (or proton exchange membrane fuel cell) (PEMFC), which has been studied most extensively as a power source for driving vehicles. The fuel cell 112A may include an end plate (not shown), a current collector (not shown), and a cell stack (not shown). The cell stack may include a plurality of stacked unit cells. Since the current collector and the end plate are parts well known in the art, detailed descriptions thereof have been omitted.

The PE part 112A may include various parts, other than the fuel cell 112A, which generate heat in an engine compartment of the vehicle.

The first radiator 114 (the 1-1^{st} radiator 114A and the 1-2^{nd} radiator 114B) serves to cool the fuel cell and the PE part 112A. For example, the first radiator 114 (the 1-1^{st} radiator 114A and the 1-2^{nd} radiator 114B) serves to dissipate heat of coolant (hereinafter referred to as “first coolant”) that has absorbed heat generated during a power generation process of the fuel cell 112A, i.e., heat of the first coolant that has cooled the fuel cell 112A, to the atmosphere.

The 1-1^{st} radiator 114A may include a first front surface FS1 facing the temperature regulator 130 and a first back surface BS1 opposite to the first front surface FS1.

The 1-2^{nd} radiator 114B may include a second front surface FS2 facing the first back surface BS1 of the 1-1^{st} radiator 114A and a second back surface BS2 opposite to the second front surface FS2.

The fan 118 is disposed so as to face the second back surface BS2 of the 1-2^{nd} radiator 114B. The fan 118 serves to control the flow of air to the first radiator 114 and/or the flow of air from the first radiator 114.

The first tank 119 serves to store the first coolant for cooling the fuel cell or the PE part 112A.

The second cooling unit 120A shown in FIG. 3 may include an automatic transmission 122A, a second radiator 124, a second tank 126, and a cooling fan 128.

The automatic transmission 122A may include parts that generate heat during auxiliary braking of the fuel cell vehicle 100.

The second radiator 124 serves to dissipate heat of coolant (hereinafter referred to as “second coolant”) that has absorbed heat generated in the automatic transmission 122A, i.e., heat of the second coolant that has cooled the automatic transmission 122A, to the atmosphere.

Each of the first and second radiators 114 and 124 corresponds to a radiator, a heat dissipation device, or a heat sink. However, the embodiments are not limited to any specific types or number of first and second radiators 114 and 124 or to the presence/absence or any specific forms of the fans 118 and 128.

The fan 128 is disposed so as to face the back surface of the second radiator 124. The fan 128 serves to control the flow of air to the second radiator 124 and/or the flow of air from the second radiator 124.

The second tank 126 serves to store the second coolant for cooling the automatic transmission 122A.

Referring again to FIG. 1, the temperature regulator 130 serves to lower the temperature of one of the first and second cooling units 110 and 120. In this case, the temperature regulator 130 may also serve to increase the temperature of the other of the first and second cooling units 110 and 120.

The first device 112 and the second device 122 described above have different degrees of heat generation. In other words, the first device 112 may generate an amount of heat greater than an amount of heat generated by the second device 122, or the second device 122 may generate an amount of heat greater than the amount of heat generated by the first device 112. When the first device 112 generates a larger amount of heat, the temperature regulator 130 serves to lower the temperature of the first device 112, and when the second device 122 generates a larger amount of heat, the temperature regulator 130 serves to lower the temperature of the second device 122. To this end, the temperature regulator 130 may be implemented in various forms.

Hereinafter, the configuration and operation of the temperature regulator 130 according to the embodiment is described with reference to the accompanying drawings.

The temperature regulator according to the embodiment may include a first condenser/evaporator, a second condenser/evaporator, a compressor, at least one expansion valve, and a plurality of 3-way valves.

The first condenser/evaporator serves to absorb heat from air supplied to the first radiator 114 (the 1-1^{st} radiator 114A and the 1-2^{nd} radiator 114B) or to emit heat to the air supplied to the first radiator 114 (the 1-1^{st} radiator 114A and the 1-2^{nd} radiator 114B).

The second condenser/evaporator serves to absorb heat from air supplied to the second radiator 124 or to emit heat to the air supplied to the second radiator 124.

In other words, each of the first condenser/evaporator and the second condenser/evaporator may operate as a condenser or may operate as an evaporator. The condenser and the evaporator perform the same functions as a condenser and an evaporator of an air-conditioner, respectively. In other words, the condenser is used for heating by emitting heat to the surroundings, and the evaporator is used for cooling by absorbing heat from the surroundings.

The compressor may be disposed between the first condenser/evaporator and the second condenser/evaporator, and the at least one expansion valve may be disposed between the first condenser/evaporator and the second condenser/evaporator.

The plurality of 3-way valves may be disposed at at least one of the inlet or the outlet of each of the first condenser/evaporator and the second condenser/evaporator, at least one of the inlet or the outlet of the compressor, and at least one of the inlet or the outlet of the expansion valve.

The controller 140 may control the plurality of 3-way valves such that the first condenser/evaporator operates as an evaporator to absorb heat from the air supplied to the first radiator 114 (the 1-1^{st} radiator 114A and the 1-2^{nd} radiator 114B) or operates as a condenser to emit heat to the air supplied to the first radiator 114 (the 1-1^{st} radiator 114A and the 1-2^{nd} radiator 114B).

In addition, the controller 140 may control the plurality of 3-way valves such that the second condenser/evaporator operates as an evaporator to absorb heat from the air supplied to the second radiator 124 or operates as a condenser to emit heat to the air supplied to the second radiator 124.

The controller 140 may generate control signals for control of passages of the plurality of 3-way valves to allow one of the first condenser/evaporator and the second condenser/evaporator to operate as a condenser and the other thereof to operate as an evaporator. In other words, by controlling the passages of the plurality of 3-way valves, one of the first condenser/evaporator and the second condenser/evaporator may operate as a condenser, while the other may operate as an evaporator.

In addition, the controller 140 may generate the control signals in response to at least one of the outside air temperature, the temperature of the first coolant that has cooled the first device 112, or the temperature of the second coolant that has cooled the second device 122. This is described in detail below.

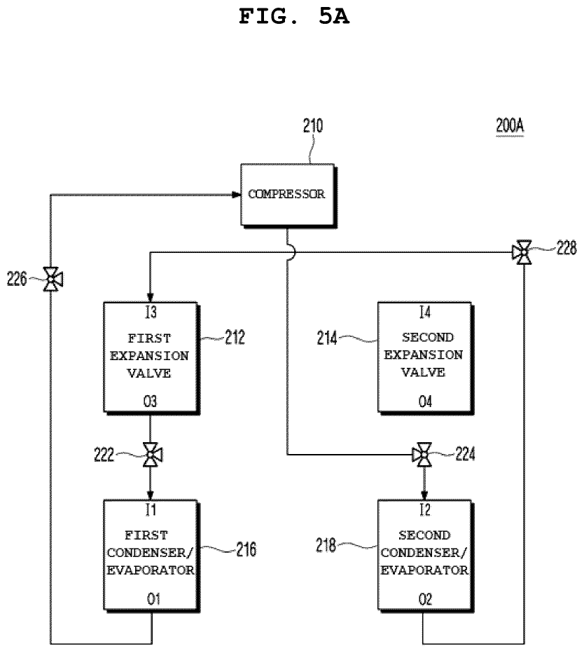

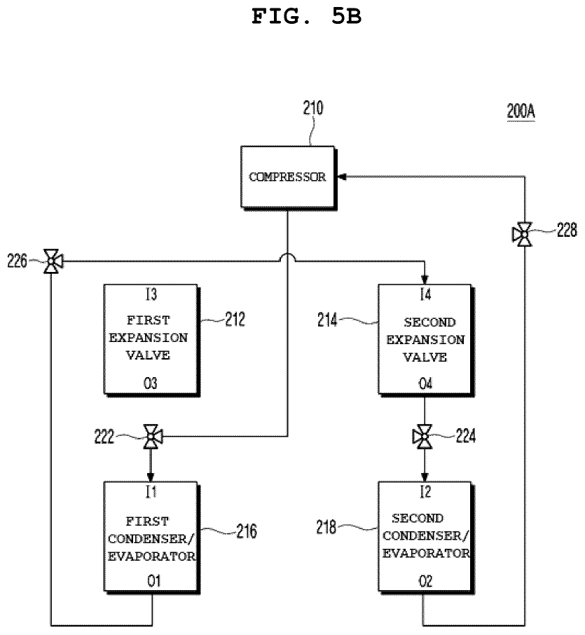

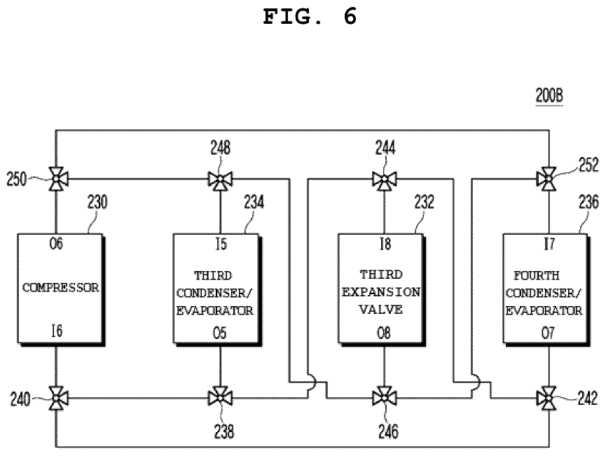

FIG. 4 is a block diagram of an embodiment 200A of the temperature regulator 130 shown in FIG. 1. FIG. 5A is a block diagram for explaining a first operation example of the temperature regulator 200A shown in FIG. 4, and FIG. 5B is a block diagram for explaining a second operation example of the temperature regulator 200A shown in FIG. 4. In FIGS. 4 to 5B, the lines interconnecting respective parts represent refrigerant flow paths. For example, the refrigerant may be next-generation refrigerant (R1234yf) or conventional refrigerant (R134a). However, the embodiments are not limited to any specific type of refrigerant.

According to an embodiment, the temperature regulator 200A may include a compressor 210, a first expansion valve 212, a second expansion valve 214, a first condenser/evaporator 216, a second condenser/evaporator 218, and a plurality of 3-way valves 222, 224, 226, and 228.

The first expansion valve 212 is disposed between an inlet I1 of the first condenser/evaporator 216 and an outlet O2 of the second condenser/evaporator 218, and the second expansion valve 214 is disposed between an outlet O1 of the first condenser/evaporator 216 and an inlet I2 of the second condenser/evaporator 218.

The plurality of 3-way valves may include 1-1^{st} to 1-4^{th} 3-way valves 222, 224, 226, and 228.

The 1-1^{st} 3-way valve 222 may be connected to an outlet O3 of the first expansion valve 212, the compressor 210, the inlet I1 of the first condenser/evaporator 216, and the 1-2^{nd} 3-way valve 224.

The 1-2^{nd} 3-way valve 224 may be connected to an outlet O4 of the second expansion valve 214, the compressor 210, the 1-1st 3-way valve 222, and the inlet I2 of the second condenser/evaporator 218.

The 1-3^{rd} 3-way valve 226 may be connected to an inlet I4 of the second expansion valve 214, the compressor 210, and the outlet O1 of the first condenser/evaporator 216.

The 1-4^{th} 3-way valve 228 may be connected to an inlet I3 of the first expansion valve 212, the compressor 210, and the outlet O2 of the second condenser/evaporator 218.

The controller 140 may generate 1-1^{st} to 1-4^{th} control signals C11, C12, C13, and C14 for respective control of the 1-1st to 1-4^{th} 3-way valves 222, 224, 226, and 228.

The temperature regulator 200A shown in FIG. 4 may perform operation shown in FIG. 5A when the 1-1^{st} to 1-4^{th} control signals C11, C12, C13, and C14 are at a first level, and may perform operation shown in FIG. 5B when the 1-1^{st} to 1-4^{th} control signals C11, C12, C13, and C14 are at a second level.

A first operation example of the 1-1^{st} to 1-4^{th} 3-way valves 222, 224, 226, and 228 when the 1-1^{st} to 1-4^{th} control signals C11, C12, C13, and C14 are at a first level is described below with reference to FIG. 5A.

The angle of the 1-1^{st} 3-way valve 222 becomes 0 degrees to connect the outlet O3 of the first expansion valve 212 to the inlet I1 of the first condenser/evaporator 216 in response to the first-level 1-1^{st} control signal C11.

The angle of the 1-2^{nd} 3-way valve 224 becomes 90 degrees to connect the compressor 210 to the inlet I2 of the second condenser/evaporator 218 in response to the first-level 1-2nd control signal C12.

The angle of the 1-3^{rd} 3-way valve 226 becomes 0 degrees to connect the compressor 210 to the outlet O1 of the first condenser/evaporator 216 in response to the first-level 1-3rd control signal C13.

The angle of the 1-4^{th} 3-way valve 228 becomes 90 degrees to connect the inlet I3 of the first expansion valve 212 to the outlet O2 of the second condenser/evaporator 218 in response to the first-level 1-4^{th} control signal C14.

A second operation example of the 1-1^{st} to 1-4^{th} 3-way valves 222, 224, 226, and 228 when the 1-1^{st} to 1-4^{th} control signals C11, C12, C13, and C14 are at a second level is described below with reference to FIG. 5B.

The angle of the 1-1^{st} 3-way valve 222 becomes 90 degrees to connect the compressor 210 to the inlet I1 of the first condenser/evaporator 216 in response to the second-level 1-1st control signal C11.

The angle of the 1-2^{nd} 3-way valve 224 becomes 0 degrees to connect the outlet O4 of the second expansion valve 214 to the inlet I2 of the second condenser/evaporator 218 in response to the second-level 1-2^{nd} control signal C12.

The angle of the 1-3^{rd} 3-way valve 226 becomes 90 degrees to connect the inlet I4 of the second expansion valve 214 to the outlet O1 of the first condenser/evaporator 216 in response to the second-level 1-3^{rd} control signal C13.

The angle of the 1-4^{th} 3-way valve 228 becomes 0 degrees to connect the compressor 210 to the outlet O2 of the second condenser/evaporator 218 in response to the second-level 1-4th control signal C14.

When the 1-1^{st} to 1-4^{th} 3-way valves 222, 224, 226, and 228 form the refrigerant flow path shown in FIG. 5A, the first condenser/evaporator 216 may operate as an evaporator to absorb heat from the surroundings, and the second condenser/evaporator 218 may operate as a condenser to emit heat to the surroundings. In this way, the 1-1^{st} to 1-4^{th} 3-way valves 222, 224, 226, and 228 may be controlled such that the first expansion valve 212 is disposed on the upstream side of the first condenser/evaporator 216 to allow the first condenser/evaporator 216 to operate as an evaporator and the compressor 210 is disposed on the upstream side of the second condenser/evaporator 218 to allow the second condenser/evaporator 218 to operate as a condenser.

When the 1-1^{st} to 1-4^{th} 3-way valves 222, 224, 226, and 228 form the refrigerant flow path shown in FIG. 5B, the first condenser/evaporator 216 may operate as a condenser to emit heat to the surroundings, and the second condenser/evaporator 218 may operate as an evaporator to absorb heat from the surroundings. In this way, the 1-1^{st} to 1-4^{th} 3-way valves 222, 224, 226, and 228 may be controlled such that the second expansion valve 214 is disposed on the upstream side of the second condenser/evaporator 218 to allow the second condenser/evaporator 218 to operate as an evaporator and the compressor 210 is disposed on the upstream side of the first condenser/evaporator 216 to allow the first condenser/evaporator 216 to operate as a condenser.

This may be understood based on the operation principle of an air-conditioner. In an air-conditioner, a condenser generates heat while liquefying high-pressure liquid refrigerant is changed to low-temperature and low-pressure gaseous refrigerant in an evaporator, thereby absorbing heat from the surroundings.

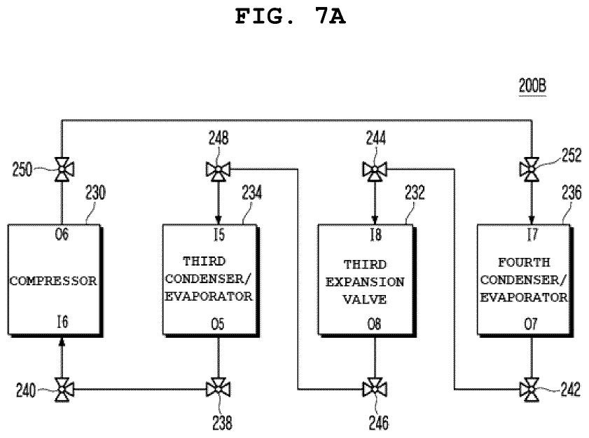

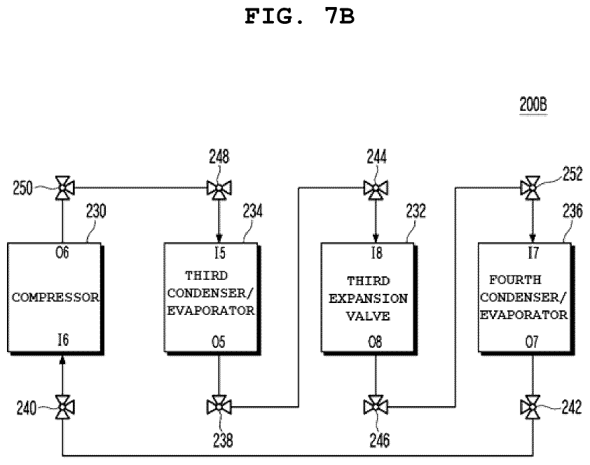

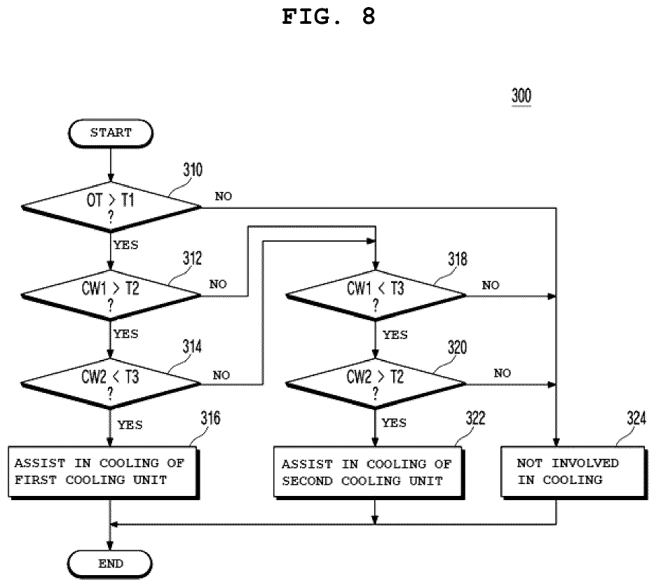

FIG. 6 is a block diagram of another embodiment 200B of the temperature regulator 130 shown in FIG. 1. FIG. 7A is a block diagram for explaining a third operation example of the temperature regulator 200B shown in FIG. 6, and FIG. 7B is a block diagram for explaining a fourth operation example of the temperature regulator 200B shown in FIG. 6. In FIGS. 6 to 7B, the lines interconnecting respective parts represent refrigerant flow paths. For example, the refrigerant may be next-generation refrigerant (R1234yf) or conventional refrigerant (R134a). However, the embodiments are not limited to any specific type of refrigerant.

According to another embodiment, the temperature regulator 200B may include a compressor 230, an expansion valve 232 (hereinafter referred to as a “third expansion valve”), a third condenser/evaporator 234, a fourth condenser/evaporator 236, and a plurality of 3-way valves 238 to 252. Here, the third condenser/evaporator 234 and the fourth condenser/evaporator 236 perform the same functions as the first condenser/evaporator 216 and the second condenser/evaporator 218 shown in FIG. 4, respectively, and the compressor 230 performs the same function as the compressor 210 shown in FIG. 4. Thus, duplicate descriptions thereof are omitted.

While the temperature regulator 200A shown in FIG. 4 includes two expansion valves 212 and 214 and four 3-way valves 222, 224, 226 and 228, the temperature regulator 200B shown in FIG. 6 may include one expansion valve 232 and eight 3-way valves 238 to 252. Except for this, the operation principle of the temperature regulator 200B shown in FIG. 6 is identical to that of the temperature regulator 200A shown in FIG. 4.

The plurality of 3-way valves may include 2-1^{st} to 2-8^{th} 3-way valves 238 to 252.

The 2-1^{st} 3-way valve 238 may be connected to an outlet O5 of the third condenser/evaporator 234, the 2-4^{th} 3-way valve 244, and the 2-2^{nd} 3-way valve 240.

The 2-2^{nd} 3-way valve 240 may be connected to an inlet I6 of the compressor 230, the 2-1^{st} 3-way valve 238, and the 2-3^{rd} 3-way valve 242.

The 2-3^{rd} 3-way valve 242 may be connected to an outlet O7 of the fourth condenser/evaporator 236, the 2-2^{nd} 3-way valve 240, and the 2-4^{th} 3-way valve 244.

The 2-4^{th} 3-way valve 244 may be connected to an inlet I8 of the third expansion valve 232, the 2-1^{st} 3-way valve 238, and the 2-3^{rd} 3-way valve 242.

The 2-5^{th} 3-way valve 246 may be connected to an outlet O8 of the third expansion valve 232, the 2-6^{th} 3-way valve 248, and the 2-8^{th} 3-way valve 252.

The 2-6^{th} 3-way valve 248 may be connected to the 2-5^{th} 3-way valve 246, the 2-7^{th} 3-way valve 250, and an inlet I5 of the third condenser/evaporator 234.

The 2-7^{th} 3-way valve 250 may be connected to an outlet O6 of the compressor 230, the 2-6^{th} 3-way valve 248, and the 2-8^{th} 3-way valve 252.

The 2-8^{th} 3-way valve 252 may be connected to an inlet I7 of the fourth condenser/evaporator 236, the 2-5^{th} 3-way valve 246, and the 2-7^{th} 3-way valve 250.

The controller 140 may generate 2-1^{st} to 2-8^{th} control signals C21 to C28 for respective control of the 2-1^{st} to 2-8^{th} 3-way valves 238, 240, 242, 244, 246, 248, 250, and 252.

The temperature regulator 200B shown in FIG. 6 may perform operation shown in FIG. 7A when the 2-1^{st} to 2-8^{th} control signals C21 to C28 are at a first level, and may perform operation shown in FIG. 7B when the 2-1^{st} to 2-8^{th} control signals C21 to C28 are at a second level.

A third operation example of the 2-1^{st} to 2-8^{th} 3-way valves 238, 240, 242, 244, 246, 248, 250, and 252 when the 2-1^{st} to 2-8th control signals C21 to C28 are at a first level is described below with reference to FIG. 7A.

The angle of the 2-1^{st} 3-way valve 238 becomes 90 degrees to connect the 2-2^{nd} 3-way valve 240 to the outlet O5 of the third condenser/evaporator 234 in response to the first-level 2-1st control signal C21.

The angle of the 2-2^{nd} 3-way valve 240 becomes 90 degrees to connect the 2-1^{st} 3-way valve 238 to the inlet I6 of the compressor 230 in response to the first-level 2-2^{nd} control signal C22.

The angle of the 2-3^{rd} 3-way valve 242 becomes 90 degrees to connect the 2-4^{th} 3-way valve 244 to the outlet O7 of the fourth condenser/evaporator 236 in response to the first-level 2-3rd control signal C23.

The angle of the 2-4^{th} 3-way valve 244 becomes 90 degrees to connect the 2-3^{rd} 3-way valve 242 to the inlet I8 of the third expansion valve 232 in response to the first-level 2-4^{th} control signal C24.

The angle of the 2-5^{th} 3-way valve 246 becomes 90 degrees to connect the outlet O8 of the third expansion valve 232 to the 2-6^{th} 3-way valve 248 in response to the first-level 2-5^{th} control signal C25.

The angle of the 2-6^{th} 3-way valve 248 becomes 90 degrees to connect the 2-5^{th} 3-way valve 246 to the inlet I5 of the third condenser/evaporator 234 in response to the first-level 2-6th control signal C26.

The angle of the 2-7^{th} 3-way valve 250 becomes 0 degrees to connect the 2-8^{th} 3-way valve 252 to the compressor 230 in response to the first-level 2-7^{th} control signal C27.

The angle of the 2-8^{th} 3-way valve 252 becomes 0 degrees to connect the 2-7^{th} 3-way valve 250 to the inlet I7 of the fourth condenser/evaporator 236 in response to the first-level 2-8th control signal C28.

A fourth operation example of the 2-1^{st} to 2-8^{th} 3-way valves 238 to 252 when the 2-1^{st} to 2-8^{th} control signals C21 to C28 are at a second level is described below with reference to FIG. 7B.

The angle of the 2-1^{st} 3-way valve 238 becomes 90 degrees to connect the 2-4^{th} 3-way valve 244 to the outlet O5 of the third condenser/evaporator 234 in response to the second-level 2-1st control signal C21.

The angle of the 2-2^{nd} 3-way valve 240 becomes 0 degrees to connect the 2-3^{rd} 3-way valve 242 to the inlet I6 of the compressor 230 in response to the second-level 2-2^{nd} control signal C22.

The angle of the 2-3^{rd} 3-way valve 242 becomes 0 degrees to connect the 2-2^{nd} 3-way valve 240 to the outlet O7 of the fourth condenser/evaporator 236 in response to the second-level 2-3rd control signal C23.

The angle of the 2-4^{th} 3-way valve 244 becomes 90 degrees to connect the 2-1^{st} 3-way valve 238 to the inlet I8 of the third expansion valve 232 in response to the second-level 2-4^{th} control signal C24.

The angle of the 2-5^{th} 3-way valve 246 becomes 90 degrees to connect the outlet O8 of the third expansion valve 232 to the 2-8^{th} 3-way valve 252 in response to the second-level 2-5^{th} control signal C25.

The angle of the 2-6^{th} 3-way valve 248 becomes 90 degrees to connect the 2-7^{th} 3-way valve 250 to the inlet I5 of the third condenser/evaporator 234 in response to the second-level 2-6th control signal C26.

The angle of the 2-7^{th} 3-way valve 250 becomes 90 degrees to connect the 2-6^{th} 3-way valve 248 to the outlet O6 of the compressor 230 in response to the second-level 2-7^{th} control signal C27.

The angle of the 2-8^{th} 3-way valve 252 becomes 90 degrees to connect the 2-5^{th} 3-way valve 246 to the inlet I7 of the fourth condenser/evaporator 236 in response to the second-level 2-8th control signal C28.

When the 2-1^{st} to 2-8^{th} 3-way valves 238 to 252 form the refrigerant flow path shown in FIG. 7A, the third condenser/evaporator 248 may operate as an evaporator to absorb heat from the surroundings, and the fourth condenser/evaporator 236 may operate as a condenser to emit heat to the surroundings. In this way, the 2-1^{st} to 2-8^{th} 3-way valves 238 to 252 may be controlled such that the third expansion valve 232 is disposed on the upstream side of the third condenser/evaporator 234 to allow the third condenser/evaporator 234 to operate as an evaporator and the compressor 230 is disposed on the upstream side of the fourth condenser/evaporator 236 to allow the fourth condenser/evaporator 236 to operate as a condenser.

When the 2-1^{st} to 2-8^{th} 3-way valves 238 to 252 form the refrigerant flow path shown FIG. 7B, in the third condenser/evaporator 234 may operate as a condenser to emit heat to the surroundings, and the fourth condenser/evaporator 236 may operate as an evaporator to absorb heat from the surroundings. In this way, the 2-1^{st} to 2-8^{th} 3-way valves 238 to 252 may be controlled such that the third expansion valve 232 is disposed on the upstream side of the fourth condenser/evaporator 236 to allow the fourth condenser/evaporator 236 to operate as an evaporator and the compressor 230 is disposed on the upstream side of the third condenser/evaporator 234 to allow the third condenser/evaporator 234 to operate as a condenser.

Hereinafter, a method 300 of controlling the temperature of the fuel cell vehicle according to an embodiment is described with reference to the accompanying drawings.

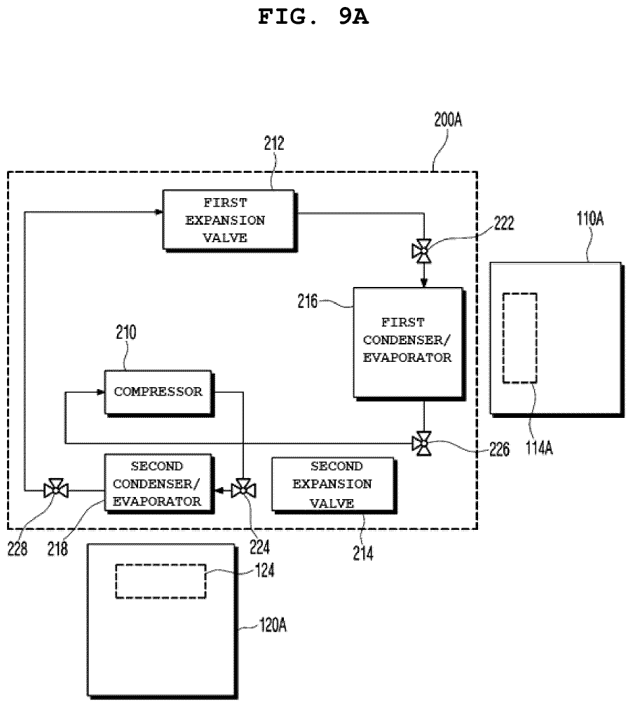

FIG. 8 is a flowchart for explaining a method 300 of controlling the temperature of the fuel cell vehicle according to an embodiment.

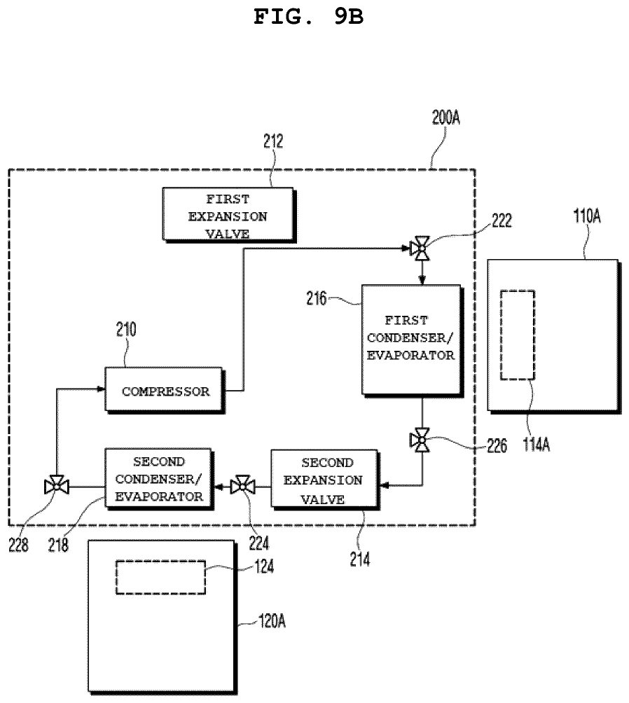

FIGS. 9A and 9B are block diagrams of the fuel cell vehicle according to the embodiment.

For better understanding, the temperature control method 300 shown in FIG. 8 is described with reference to FIGS. 9A and 9B. However, the method 300 shown in FIG. 8 may also be performed by a fuel cell vehicle configured differently from the fuel cell vehicle shown in FIGS. 9A and 9B.

The fuel cell vehicle shown in FIGS. 9A and 9B includes the first cooling unit 110A shown in FIG. 2, the second cooling unit 120A shown in FIG. 3, and the temperature regulator 200A shown in FIG. 4. For convenience of description, only the radiators 114A and 124 of the first and second cooling units 110A and 120A are shown in FIGS. 9A and 9B. FIG. 9A shows a case in which the 1-1^{st} to 1-4^{th} 3-way valves 222, 224, 226, and 228 of the temperature regulator 200A form the refrigerant flow path shown in FIG. 5A, and FIG. 9B shows a case in which the 1-1^{st} to 1-4^{th} 3-way valves 222, 224, 226, and 228 of the temperature regulator 200A form the refrigerant flow path shown in FIG. 5B.

As shown in FIGS. 9A and 9B, the first condenser/evaporator 216 may be disposed close to the front surface of the first radiator 114A into which air flows, and the second condenser/evaporator 218 may be disposed close to the front surface of the second radiator 124 into which air flows.

First, whether the outside air temperature OT is higher than a first predetermined temperature T1 is determined (step 310). For example, the first predetermined temperature T1 may be 45° C. However, the embodiments are not limited to any specific value of the first predetermined temperature T1.

If the outside air temperature OT is not higher than the first predetermined temperature T1, the temperature regulator 200A may not be involved in cooling the first and second cooling units 110A and 120A (step 324). In this case, the compressor 210 is turned off, the angle of the 1-1^{st} 3-way valve 222 becomes 0 degrees to connect the first expansion valve 212 to the first condenser/evaporator 216, the angle of the 1-2^{nd} 3-way valve 224 becomes 90 degrees to connect the second condenser/evaporator 218 to the compressor 210 and the 1-1^{st} 3-way valve 222, the angle of the 1-3^{rd} 3-way valve 226 becomes 90 degrees to connect the first condenser/evaporator 216 to the compressor 210 and the 1-4^{th} 3-way valve 228, and the angle of the 1-4^{th} 3-way valve 228 becomes 0 degrees to connect the first expansion valve 212 to the second condenser/evaporator 218.

If the outside air temperature OT is higher than the first predetermined temperature T1, whether the temperature CW1 of the first coolant is higher than a second predetermined temperature T2 is determined (step 312).

For example, the second predetermined temperature T2 may be 70° C. However, the embodiments are not limited to any specific value of the second predetermined temperature T2.

If the temperature CW1 of the first coolant is higher than the second predetermined temperature T2, whether the temperature CW2 of the second coolant is lower than a third predetermined temperature T3 is determined (step 314).

For example, the third predetermined temperature T3 may be 60° C. However, the embodiments are not limited to any specific value of the third predetermined temperature T3.

If the temperature CW2 of the second coolant is lower than the third predetermined temperature T3, the temperature regulator 200A may assist in cooling of the first cooling unit 110A (step 316).

In other words, in a state in which the outside air temperature OT is higher than the first predetermined temperature T1, if the temperature CW1 of the first coolant is higher than the second predetermined temperature T2 and if the temperature CW2 of the second coolant is lower than the third predetermined temperature T3, it is determined that the amount of heat generated in the first device 112 is greater than the amount of heat generated in the second device 122, and the above-described 1-1st to 1-4^{th} control signals C11 to C14 are generated to have a first level, so that the 1-1^{st} to 1-4^{th} 3-way valves 222 to 228 are controlled to form the refrigerant flow path shown in FIG. 9A. Accordingly, the first condenser/evaporator 216 operates as an evaporator to absorb heat from outside air that is to flow into the first radiator 114A of the first cooling unit 110A so that the cooled air is supplied to the first radiator 114A, and the second condenser/evaporator 218 operates as a condenser to emit heat to the second cooling unit 120A.

If the temperature CW1 of the first coolant is equal to or lower than the second predetermined temperature T2 or if the temperature CW2 of the second coolant is equal to or higher than the third predetermined temperature T3, whether the temperature CW1 of the first coolant is lower than the third predetermined temperature T3 is determined (step 318). If the temperature CW1 of the first coolant is lower than the third predetermined temperature T3, whether the temperature CW2 of the second coolant is higher than the second predetermined temperature T2 is determined (step 320). If the temperature CW2 of the second coolant is higher than the second predetermined temperature T2, the temperature regulator 200A may assist in cooling of the second cooling unit 120A (step 322).

In other words, in a state in which the outside air temperature OT is higher than the first predetermined temperature T1, if the temperature CW1 of the first coolant is lower than the third predetermined temperature T3 and if the temperature CW2 of the second coolant is higher than the second predetermined temperature T2, it is determined that the amount of heat generated in the second device 122 is greater than the amount of heat generated in the first device 112, and the above-described 1-1st to 1-4^{th} control signals C11 to C14 are generated to have a second level, so that the 1-1^{st} to 1-4^{th} 3-way valves 222 to 228 are controlled to form the refrigerant flow path shown in FIG. 9B. Accordingly, the second condenser/evaporator 218 operates as an evaporator to absorb heat from outside air that is to flow into the second radiator 124 of the second cooling unit 120A so that the cooled air is supplied to the second radiator 124, and the first condenser/evaporator 216 operates as a condenser to emit heat to the first cooling unit 110A.

If the temperature CW1 of the first coolant is equal to or higher than the third predetermined temperature T3 or if the temperature CW2 of the second coolant is equal to or lower than the second predetermined temperature T2, the process proceeds to step 324.

When the fuel cell vehicle 100 accelerates, the first device 112 of the first cooling unit 110A may generate a larger amount of heat than the second device 122, and thus the temperature CW1 of the first coolant may be higher than the second predetermined temperature T2, and the temperature CW2 of the second coolant may be lower than the third predetermined temperature T3. In this case, the 1-1^{st} to 1-4^{th} 3-way valves 222 to 228 are controlled to form the refrigerant flow path shown in FIG. 9A, whereby the first condenser/evaporator 216 operates as an evaporator, and the second condenser/evaporator 218 operates as a condenser. Accordingly, the first condenser/evaporator 216 absorbs heat from air that is to flow into the 1-1^{st} radiator 114A of the first cooling unit 110A, and the second condenser/evaporator 218 emits heat to air that is to flow into the second radiator 124 of the second cooling unit 120A. Therefore, the cooled air, the temperature of which is much lower than that of the outside air, may be provided to the 1-1^{st} radiator 114A. In this way, the temperature regulator 200A may assist in cooling of the first cooling unit 110A in a high-temperature environment, thereby improving the efficiency and cooling performance of the fan 118.

On the other hand, when the fuel cell vehicle travels downhill, the second device 122 of the second cooling unit 120A may generate a larger amount of heat than the first device 112, and thus the temperature CW2 of the second coolant may be higher than the second predetermined temperature T2, and the temperature CW1 of the first coolant may be lower than the third predetermined temperature T3. In this case, the 1-1^{st} to 1-4^{th} 3-way valves 222 to 228 are controlled to form the refrigerant flow path shown in FIG. 9B, whereby the second condenser/evaporator 218 operates as an evaporator, and the first condenser/evaporator 216 operates as a condenser. Accordingly, the second condenser/evaporator 218 absorbs heat from air that is to flow into the second radiator 124 of the second cooling unit 120A, and the first condenser/evaporator 216 emits heat to air that is to flow into the 1-1^{st} radiator 114A of the first cooling unit 110A. Therefore, the cooled air, the temperature of which is much lower than that of the outside air, may be provided to the second radiator 124. In this way, the temperature regulator 200A may assist in cooling of the second cooling unit 120A in a high-temperature environment, thereby improving the efficiency and cooling performance of the fan 128.

Hereinafter, the fuel cell vehicle and the method of controlling the temperature thereof according to the embodiments and a comparative example are described.

When a fuel cell vehicle is driven, a stack or a PE part may generate a larger amount of heat than an automatic transmission. On the other hand, during auxiliary braking of the fuel cell vehicle, the automatic transmission may generate a larger amount of heat than the fuel cell or the PE part.

In a fuel cell vehicle of the comparative example, an evaporator assisting in cooling of a fuel cell or a PE part and an evaporator assisting in cooling of an automatic transmission are separately provided, and a condenser emitting heat to the fuel cell or the PE part and a condenser emitting heat to the automatic transmission are separately provided. Therefore, the capacity of a package associated with temperature regulation may increase.

In contrast, according to the embodiment, in a state in which the outside air temperature is high, the plurality of 3-way valves may be controlled such that one condenser/evaporator selectively operates as a condenser or an evaporator, thereby reducing the capacity of the cooling package. Further, among the first and second cooling units 110 and 120 that respectively include the first and second devices 112 and 122 having different degrees of heat generation depending on the operational state of the vehicle (driving or braking), the temperature regulator 130, 200A, or 200B may selectively assist in cooling of the cooling unit that requires more cooling. Accordingly, the size of the cooling package may be reduced. Especially, burden on the cooling capacity in tropical areas may be reduced.

In addition, since the temperature regulator 130, 200A, or 200B assists in cooling of the first and second cooling units 110 and 120, the size of the radiators 114 and 124 or the fans 118 and 128 included in the first and second cooling units 110 and 120 may be reduced. Therefore, a cooling module having an overall compact structure may be developed.

As is apparent from the above description, in a fuel cell vehicle according to an embodiment, since the size of a cooling package is reduced, burden on the cooling capacity in especially tropical areas may be reduced, and a cooling module having an overall compact structure may be developed.

The effects achievable through the disclosure are not limited to the above-mentioned effects, and other effects not mentioned herein will be clearly understood by those skilled in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been particularly shown and described with reference to some embodiments thereof, these embodiments are only proposed for illustrative purposes, and do not restrict the present disclosure, and it should be apparent to those having ordinary skill in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A fuel cell vehicle, comprising:
a first cooling unit configured to cool a first device;
a second cooling unit configured to cool a second device; and
a temperature regulator configured to lower a temperature of one of the first and second cooling units and to increase a temperature of a remaining one of the first and second cooling units,
wherein the first device and the second device have different degrees of heat generation.

2. The fuel cell vehicle according to claim 1, wherein the first device includes a fuel cell or a power electronic part, and
wherein the second device includes an automatic transmission related to auxiliary braking.

3. The fuel cell vehicle according to claim 2, wherein the first cooling unit includes a first radiator configured to cool a first coolant having cooled the first device, and
wherein the second cooling unit includes a second radiator configured to cool a second coolant having cooled the second device.

4. The fuel cell vehicle according to claim 3, wherein the temperature regulator includes:
a first condenser/evaporator configured to absorb heat from air to be supplied to the first radiator or emit heat to the air;
a second condenser/evaporator configured to absorb heat from air to be supplied to the second radiator or to emit heat to the air;
a compressor disposed between the first condenser/evaporator and the second condenser/evaporator;
at least one expansion valve disposed between the first condenser/evaporator and the second condenser/evaporator; and
a plurality of 3-way valves disposed at at least one of an inlet or an outlet of each of the first condenser/evaporator and the second condenser/evaporator, at least one of an inlet or an outlet of the compressor, and at least one of an inlet or an outlet of the at least one expansion valve.

5. The fuel cell vehicle according to claim 4, further comprising a controller configured to generate control signals for control of passages of the plurality of 3-way valves to allow one of the first condenser/evaporator and the second condenser/evaporator to operate as a condenser and a remaining one of the first condenser/evaporator and the second condenser/evaporator to operate as an evaporator.

6. The fuel cell vehicle according to claim 5, wherein the controller is configured to generate the control signals in response to at least one of an outside air temperature, a temperature of the first coolant having cooled the first device, or a temperature of the second coolant having cooled the second device.

7. The fuel cell vehicle according to claim 6, wherein the at least one expansion valve includes:
a first expansion valve disposed between the inlet of the first condenser/evaporator and the outlet of the second condenser/evaporator; and
a second expansion valve disposed between the outlet of the first condenser/evaporator and the inlet of the second condenser/evaporator, and
wherein the plurality of 3-way valves includes:
a 1-1^{st} 3-way valve connected to an outlet of the first expansion valve, the compressor, and the inlet of the first condenser/evaporator;
a 1-2^{nd} 3-way valve connected to an outlet of the second expansion valve, the compressor, the 1-1^{st} 3-way valve, and the inlet of the second condenser/evaporator;
a 1-3^{rd} 3-way valve connected to an inlet of the second expansion valve, the compressor, and the outlet of the first condenser/evaporator; and
a 1-4^{th} 3-way valve connected to an inlet of the first expansion valve, the compressor, and the outlet of the second condenser/evaporator.

8. The fuel cell vehicle according to claim 7, wherein the control signals include 1-1^{st} to 1-4^{th} control signals for respective control of the 1-1^{st} to 1-4^{th} 3-way valves, and
wherein, when the 1-1^{st} to 1-4^{th} control signals are at a first level,
the 1-1^{st} 3-way valve is configured to connect the outlet of the first expansion valve to the inlet of the first condenser/evaporator in response to the first-level 1-1^{st} control signal,
the 1-2^{nd} 3-way valve is configured to connect the compressor to the inlet of the second condenser/evaporator in response to the first-level 1-2^{nd} control signal,
the 1-3^{rd} 3-way valve is configured to connect the compressor to the outlet of the first condenser/evaporator in response to the first-level 1-3^{rd} control signal, and
the 1-4^{th} 3-way valve is configured to connect the inlet of the first expansion valve to the outlet of the second condenser/evaporator in response to the first-level 1-4^{th} control signal.

9. The fuel cell vehicle according to claim 8, wherein, when the 1-1^{st} to 1-4^{th} control signals are at a second level,
the 1-1^{st} 3-way valve is configured to connect the compressor to the inlet of the first condenser/evaporator in response to the second-level 1-1^{st} control signal,
the 1-2^{nd} 3-way valve is configured to connect the outlet of the second expansion valve to the inlet of the second condenser/evaporator in response to the second-level 1-2^{nd} control signal,
the 1-3^{rd} 3-way valve is configured to connect the inlet of the second expansion valve to the outlet of the first condenser/evaporator in response to the second-level 1-3^{rd} control signal, and
the 1-4^{th} 3-way valve is configured to connect the compressor to the outlet of the second condenser/evaporator in response to the second-level 1-4^{th} control signal.

10. The fuel cell vehicle according to claim 6, wherein the at least one expansion valve includes a third expansion valve, and
wherein the plurality of 3-way valves includes:
a 2-1^{st} 3-way valve connected to the outlet of the first condenser/evaporator;
a 2-2^{nd} 3-way valve connected to the compressor and the 2-1^{st} 3-way valve;
a 2-3^{rd} 3-way valve connected to the outlet of the second condenser/evaporator and the 2-2^{nd} 3-way valve;
a 2-4^{th} 3-way valve connected to an inlet of the third expansion valve, the 2-3^{rd} 3-way valve, and the 2-1^{st} 3-way valve;
a 2-5^{th} 3-way valve connected to an outlet of the third expansion valve;
a 2-6^{th} 3-way valve connected to the 2-5^{th} 3-way valve and the inlet of the first condenser/evaporator;
a 2-7^{th} 3-way valve connected to the compressor and the 2-6^{th} 3-way valve; and
a 2-8^{th} 3-way valve connected to the inlet of the second condenser/evaporator, the 2-7^{th} 3-way valve, and the 2-5^{th} 3-way valve.

11. The fuel cell vehicle according to claim 10, wherein the control signals include 2-1^{st} to 2-8^{th} control signals for respective control of the 2-1^{st} to 2-8^{th} 3-way valves, and
wherein, when the 2-1^{st} to 2-8^{th} control signals are at a first level,
the 2-1^{st} 3-way valve is configured to connect the 2-2^{nd} 3-way valve to the outlet of the first condenser/evaporator in response to the first-level 2-1^{st} control signal,
the 2-2^{nd} 3-way valve is configured to connect the 2-1^{st} 3-way valve to the compressor in response to the first-level 2-2^{nd} control signal,
the 2-3^{rd} 3-way valve is configured to connect the 2-4^{th} 3-way valve to the outlet of the second condenser/evaporator in response to the first-level 2-3^{rd} control signal,
the 2-4^{th} 3-way valve is configured to connect the 2-3^{rd} 3-way valve to the inlet of the third expansion valve in response to the first-level 2-4^{th} control signal,
the 2-5^{th} 3-way valve is configured to connect the outlet of the third expansion valve to the 2-6^{th} 3-way valve in response to the first-level 2-5^{th} control signal,
the 2-6^{th} 3-way valve is configured to connect the 2-5^{th} 3-way valve to the inlet of the first condenser/evaporator in response to the first-level 2-6^{th} control signal,
the 2-7^{th} 3-way valve is configured to connect the 2-8^{th} 3-way valve to the compressor in response to the first-level 2-7^{th} control signal, and
the 2-8^{th} 3-way valve is configured to connect the 2-7^{th} 3-way valve to the inlet of the second condenser/evaporator in response to the first-level 2-8^{th} control signal.

12. The fuel cell vehicle according to claim 11, wherein, when the 2-1^{st} to 2-8^{th} control signals are at a second level,
the 2-1^{st} 3-way valve is configured to connect the 2-4^{th} 3-way valve to the outlet of the first condenser/evaporator in response to the second-level 2-1^{st} control signal,
the 2-2^{nd} 3-way valve is configured to connect the 2-3^{rd} 3-way valve to the compressor in response to the second-level 2-2^{nd} control signal,
the 2-3^{rd} 3-way valve is configured to connect the 2-2^{nd} 3-way valve to the outlet of the second condenser/evaporator in response to the second-level 2-3^{rd} control signal,
the 2-4^{th} 3-way valve is configured to connect the 2-1^{st} 3-way valve to the inlet of the third expansion valve in response to the second-level 2-4^{th} control signal,
the 2-5^{th} 3-way valve is configured to connect the outlet of the third expansion valve to the 2-8^{th} 3-way valve in response to the second-level 2-5^{th} control signal,
the 2-6^{th} 3-way valve is configured to connect the 2-7^{th} 3-way valve to the inlet of the first condenser/evaporator in response to the second-level 2-6^{th} control signal,
the 2-7^{th} 3-way valve is configured to connect the 2-6^{th} 3-way valve to the compressor in response to the second-level 2-7^{th} control signal, and
the 2-8^{th} 3-way valve is configured to connect the 2-5^{th} 3-way valve to an inlet of the second condenser/evaporator in response to the second-level 2-8^{th} control signal.

13. A method of controlling a temperature of a fuel cell vehicle including a first cooling unit, a second cooling unit and a temperature regulator to control a temperature of the first and second cooling units, where the first cooling unit includes a first radiator configured to cool a first coolant having cooled a first device, and the second cooling unit includes a second radiator configured to cool a second coolant having cooled a second device, the method comprising:
determining whether an outside air temperature is higher than a first predetermined temperature;
when the outside air temperature is higher than the first predetermined temperature, determining whether a temperature of the first coolant is higher or lower than a second predetermined temperature and whether a temperature of the second coolant is higher or lower than a third predetermined temperature, wherein the first device and the second device have different degrees of heat generation;
when the temperature of the first coolant is higher than the second predetermined temperature and when the temperature of the second coolant is lower than the third predetermined temperature, generating, by a controller, a first control signal to have a first level; and
when the temperature of the first coolant is lower than the third predetermined temperature and when the temperature of the second coolant is higher than the second predetermined temperature, generating, by the controller, a second control signal to have a second level,
wherein upon receiving the first and second controls, passages of a plurality of 3-way valves are controlled to allow one of a first condenser/evaporator and a second condenser/evaporator to operate as a condenser and a remaining one of the first condenser/evaporator and the second condenser/evaporator to operate as an evaporator.

14. A method of controlling a temperature of a fuel cell vehicle including first and second cooling units, respectively including first and second devices having different degrees of heat generation, and a temperature regulator configured to lower a temperature of one of the first and second cooling units and to increase a temperature of a remaining one of the first and second cooling units, the method comprising:
determining whether an outside air temperature is higher than a first predetermined temperature;
when the outside air temperature is higher than the first predetermined temperature, when a temperature of first coolant having cooled the first device is higher than a second predetermined temperature, and when a temperature of second coolant having cooled the second device is lower than a third predetermined temperature, assisting in cooling of the first cooling unit through the temperature regulator; and
when the outside air temperature is higher than the first predetermined temperature, when the temperature of the first coolant is lower than the third predetermined temperature, and when the temperature of the second coolant is higher than the second predetermined temperature, assisting in cooling of the second cooling unit through the temperature regulator.
